(19) United States
(12) Patent Application Publication
(10) Pub. No.: US 2022/0203273 A1
(43) Pub. Date: Jun. 30, 2022

(54) MULTI-SHAFT LAMINATED SPIRAL SOLID-LIQUID SEPARATOR

(71) Applicant: YUNPING WU, FUZHOU CITY (CN)

(72) Inventor: YUNPING WU, FUZHOU CITY (CN)

(21) Appl. No.: 17/699,202

(22) Filed: Mar. 21, 2022

Related U.S. Application Data
(63) Continuation-in-part of application No. 16/321,830, filed on Jan. 30, 2019, now abandoned.

(51) Int. Cl. B01D 29/48; B01D 29/46

(52) U.S. Cl. CPC B01D 29/48; B01D 29/46

(57) ABSTRACT

Disclosed is a multi-shaft laminated spiral solid-liquid separator, the separator comprising fixed rings, movable rings and screw shafts), wherein each of the screw shafts is provided with the fixed rings and the movable rings in a staggered arrangement in a radial direction to form a cavity; there are two or more screw shafts arranged in the cavity side by side, and the fixed rings and the movable rings are in a form of an annular structure with two rings staggered and communicated or multiple rings staggered and communicated.

### BACKGROUND OF THE INVENTION

### 1. Technical Field

The present invention relates to the technical field of solid-liquid separation equipment, and in particular, to a multi-shaft laminated spiral solid-liquid separator.

### 2. Background

Chinese invention patent No. 200780018706.9 discloses a laminated spiral solid-liquid separator, which includes: a solid-liquid separation part provided with multiple adjacent fixed rings and multiple movable rings disposed between the adjacent fixed rings; and at least one screw extending through the solid-liquid separation part. The movable rings are designed to be driven by the rotating screw, in such a manner that the filtrate from a processed object entering the solid-liquid separation part is drained out of the solid-liquid separation part while the processed object is moved towards an outlet of the solid-liquid separation part. For this laminated spiral solid-liquid separator, the contact between the movable rings and a screw shaft leads to abrasion therebetween.

Chinese invention patent No. 200810043376.5 discloses a novel spiral solid-liquid separator, where movable rings are eccentrically driven by an eccentric shaft to avoid abrasion between the movable rings and the screw shaft. However, for a drive manner using such a structure, deformation easily occurs since no extra support part is provided on the eccentric shaft. Even worse, a large machine cannot be driven due to high load bearing. In addition, a drive rod for driving the movable rings easily deforms and bends.

Chinese invention patent No. 200510054707.1 discloses an anti-wear laminated spiral solid-liquid separator, where fixed rings and movable rings are arranged in tiers to jointly form a cavity structure, and a screw shaft passes through the cavity structure. The movable rings are driven up and down by an external driver, but can only move around the periphery of the screw shaft. During processing of high-fiber-content sludge which easily hardens, the materials easily accumulate on the screw shaft and cannot be propelled smoothly, reducing the processing capacity and easily causing overload or a machine failure. Moreover, no effective moisture is separated from the sludge near the shaft center and drained out of a channel, failing to reduce its moisture content.

Chinese invention patent No. 200510054707.1 discloses a solid-liquid separator with two screw shafts. However, in this machine, a cover is provided around the upper portions of the screw shafts, and a movable plate or fixed plate is provided on their lower portions. The movable plate contacts the screw shafts, which inevitably causes abrasion.

### SUMMARY OF THE INVENTION

A technical problem to be solved by the present invention is to provide a multi-shaft laminated spiral solid-liquid separator, where a drive rod is less likely to deform and is applicable to a large-scale apparatus.

The present invention is implemented as follows:

A multi-shaft laminated spiral solid-liquid separator includes: fixed rings, movable rings and screw shafts, where each of the screw shafts is provided with the fixed rings and the movable rings in a staggered arrangement in a radial direction to form a cavity.

There are two or more screw shafts arranged in the cavity side by side, and the fixed rings and the movable rings are in a form of an annular structure with two rings staggered and communicated or multiple rings staggered and communicated.

The separator further includes a primary drive rod, a secondary drive rod, and a guide rod.

The primary drive rod is connected to an independent drive motor, or is connected to the screw shafts via a transmission mechanism.

The primary drive rod is supported by two or more support devices, and one or more eccentric devices are provided on the primary drive rod.

The second drive rod passes through one end of each of the movable rings, the guide rod passes through another end of each of the movable rings, so as to connect all of the movable rings together to form one piece.

Each of the eccentric devices is fixedly connected a drive sheet, the drive sheet and a corresponding one of the movable rings are integrally formed, so that each of the eccentric devices is connected to the secondary drive rod via the drive sheet and the movable ring.

Each of the support devices has a linear guide device and a giving-way hole, the guide rod passes through the linear guide device, the secondary drive rod passes through the giving-way hole, and a diameter of the giving-way hole is at least greater than a diameter of the secondary drive rod plus an eccentric distance, so that the secondary drive rod drives the one end of the movable rings to make a circular motion while the guide rod drives the another end of the movable rings to move up and down by the linear guide device.

The transmission mechanism or the drive motor drives the primary drive rod to move, the eccentric devices on the primary drive rod drive the secondary drive rod to move, and the secondary drive rod drives all the movable rings to move.

Further, the primary drive rod and the guide rod are arranged on one side of the cavity, and the secondary drive rod is arranged on another side of the cavity.

Further, the primary drive rod and the secondary drive rod are arranged on one side of the cavity; and the guide rod is arranged on another side of the cavity.

Further, the transmission mechanism is a gear transmission mechanism; there are two screw shafts; the screw shafts are driven by the gear transmission mechanism to operate in the same direction; the gear transmission mechanism includes a driving screw shaft gear, a driven screw shaft gear, a transmission gear, and a primary drive rod gear; and the transmission gear engages with the driving screw shaft gear, the driven screw shaft gear, and the primary drive rod gear.

Further, the transmission mechanism is a gear transmission mechanism; there are two screw shafts; the screw shafts are driven by a gear transmission mechanism to operate in reverse directions; the gear transmission mechanism includes a driving screw shaft gear, a driven screw shaft gear, a transmission gear, and a primary drive rod gear; the driving screw shaft gear engages with the transmission gear and the driven screw shaft gear; and the transmission gear further engages with the primary drive rod gear.

The present invention has the following advantages: 1. The present invention uses two or more screw shafts to replace one screw shaft, and blades of the adjacent screw shafts partially overlap. Therefore, during rotation of the screw shafts, materials which easily harden into a block near the shaft centers are rolled, to successively push materials forward. Thus, all the materials are thoroughly and uniformly rolled to the periphery of the cavity, facilitating drainage of moisture. Moreover, the screw shafts are arranged side by side, and the fixed rings and the movable rings cling to the screw shafts on the circumference. Therefore, the whole cavity is flat, and the drainage area at the bottom is widened, thus better facilitating the drainage of moisture. Especially, when the screw shafts operate in reverse directions, the moisture content in the materials which can withstand the stress can be further reduced since the screw blades get close to each other during operation. 2. The primary drive rod of the present invention is arranged outside the solid-liquid separation cavity, and is supported by two or more support devices. Further, the primary drive rod is provided with multiple eccentric devices which drive the movable rings to move. Therefore, abrasion caused by the contact between the movable rings and the screw shafts is avoided, and further a multi-shaft design is made feasible. In addition, such a drive manner fundamentally eliminates occurrence of deformation of the drive rod in the prior art. 3. Gear transmission is applied between shafts to adapt to the increased volume of the cavity, which enhances the processing capacity of each individual shaft by using an energy-efficient method. 4. The primary drive rod is disposed above a water extractor, thus avoiding the eccentric devices and the support devices on the primary drive rod from being frequently immersed in waste water, and facilitating observation of driver operation and maintenance and replacement.

### BRIEF DESCRIPTION OF THE DRAWINGS

The present invention is further described below with reference to the accompanying drawings.

FIG. 1 is a schematic structural illustration according to a first embodiment of the present invention;

FIG. 2 is a schematic structural illustration of a support plate according to the first embodiment of the present invention;

FIG. 3 is a schematic structural illustration of a fixed ring according to the first embodiment of the present invention;

FIG. 4 is a schematic structural illustration of a movable ring according to the first embodiment of the present invention;

FIG. 5 is a schematic structural illustration of a transmission movable ring according to the first embodiment of the present invention;

FIG. 6A to FIG. 6C are partial schematic views of a continuous operation of a multi-shaft laminated spiral solid-liquid separator according to the first embodiment of the present disclosure;

FIG. 7 is a top view when two screw shafts operate in the same direction (a primary drive rod is not shown) according to the first embodiment of the present invention;

FIG. 8 is a schematic structural illustration of a gear transmission mechanism when the two screw shafts operate in the same direction according to the first embodiment of the present invention;

FIG. 9 is a top view when the two screw shafts operate in reverse directions (a primary drive rod is not shown) according to the first embodiment of the present invention;

FIG. 10 is a schematic structural diagram of a gear transmission mechanism when the two screw shafts operate in reverse directions according to the first embodiment of the present invention;

FIG. 11 is a schematic structural illustration according to a second embodiment of the present invention;

FIG. 12 is a schematic structural illustration of a support plate according to the second embodiment of the present invention;

FIG. 13 is a schematic structural illustration of a fixed ring according to the second embodiment of the present invention;

FIG. 14 is a schematic structural illustration of a movable ring according to the second embodiment of the present invention;

FIG. 15 is a schematic structural illustration of a transmission movable ring according to the second embodiment of the present invention;

FIG. 16A to FIG. 16C are partial schematic views of a continuous operation of a multi-shaft laminated spiral solid-liquid separator according to the second embodiment of the present disclosure;

FIG. 17 is a top view when two screw shafts operate in the same direction (a primary drive rod is not shown) according to the second embodiment of the present invention;

FIG. 18 is a schematic structural illustration of a gear transmission mechanism when the two screw shafts operate in the same direction according to the second embodiment of the present invention;

FIG. 19 is a top view when the two screw shafts operate in reverse directions (a primary drive rod is not shown) according to the second embodiment of the present invention;

FIG. 20 is a schematic structural diagram of a gear transmission mechanism when the two screw shafts operate in reverse directions according to the second embodiment of the present invention; and

FIG. 21 is a schematic structural illustration according to a third embodiment of the present invention.

### DETAILED DESCRIPTION OF THE PREFERRED EMBODIMENTS

### First Embodiment

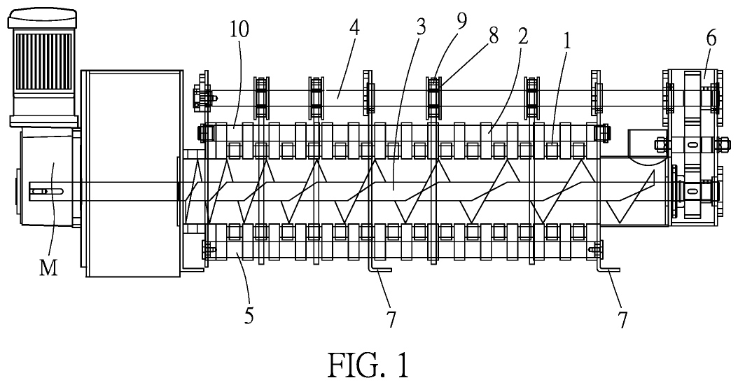

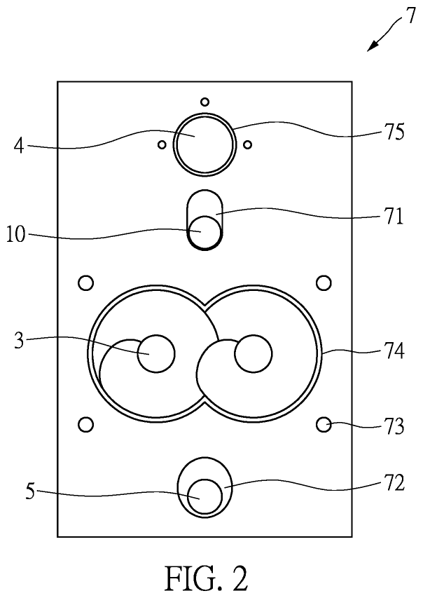

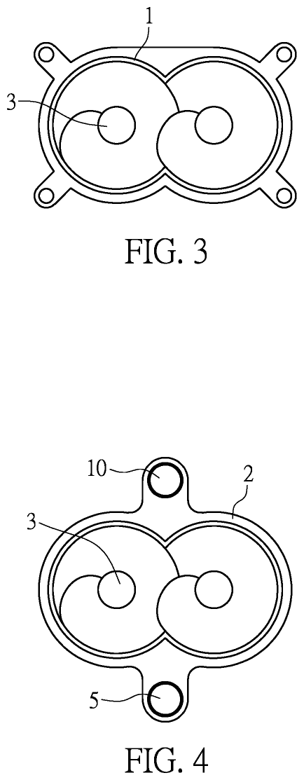

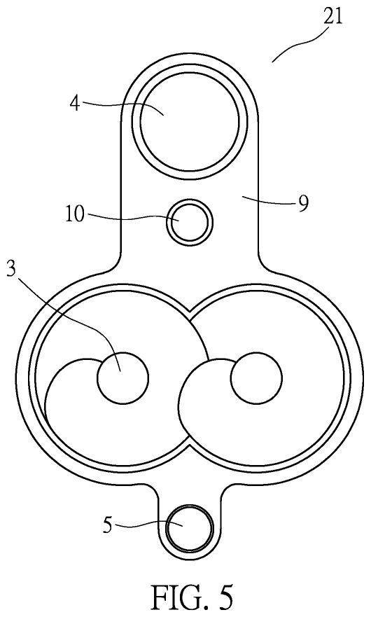

As shown in FIG. 1 to FIG. 5, a first embodiment of the present disclosure provides a multi-shaft laminated spiral solid-liquid separator, which includes fixed rings 1, movable rings 2, and two screw shafts 3 arranged side by side. Each of the two screw shafts correspondingly passes through the fixed rings 1 and the movable rings 2. In addition, each of the screw shafts 3 is provided with the fixed rings 1 and the movable rings 2 in a staggered arrangement in a radial direction to form a cavity.

The separator further includes a primary drive rod 4, a secondary drive rod 5, and a guide rod 10.

The screw shafts 3 are connected to the primary drive rod 4 via a transmission mechanism 6, where the transmission mechanism 6 may use gear transmission, sprocket transmission, or belt transmission. However, the primary drive rod 4 is not necessarily driven by the screw shafts 3, and may also be connected to and driven by an independent drive motor. In the present embodiment, the primary drive rod 4 is driven by the screw shafts 3. That is, the screw shafts 3 are connected to a drive motor M, and an operation of the drive motor M drive the screw shafts 3 and the primary drive rod 4 that is connected to the screw shafts 3 via the transmission mechanism 6.

In the present embodiment, the primary drive rod 4 is disposed on one side of the cavity and the secondary drive rod 5 is disposed on another side of the cavity that is opposite to the one side of the cavity. The primary drive rod 4 is supported by at least two support plates 7. The at least two support plates can respectively be arranged at two positions corresponding to two ends or any two positions of the screw shaft 3, and the arrangement of the at least two support plates can be adjusted according to practical requirements. Four eccentric bearings 8 are provided on the primary drive rod 4 at intervals.

Each of the eccentric bearings 8 is fixedly connected to a drive sheet 9. The drive sheets 9 and their corresponding movable rings 2 are integrally formed and the second drive rod 5 passes through one end of each of the movable rings 2, so that each of the eccentric bearings 8 is connected to the secondary drive rod 5 via the drive sheet 9. The movable ring 2 provided with the drive sheet 9 is referred to as a transmission movable ring 21.

According to the above, the second drive rod 5 passes through the one end of each of the movable rings 2, and the guide rod 10 passes through another end of each of the movable rings 2, thereby connecting all of the movable rings 2 together to form one piece.

The support plate 7 is provided with a guide device 71, a giving-way hole 72, pillar holes 73 connected to the fixed ring 1, a cavity hole 74 for accommodating a solid-liquid separation part, and a fixing hole 75 for fixing the primary drive rod 4. The guide device 71 is adjacent to the fixing hole 75, and the giving-way hole 72 is away from the fixing hole 75.

The guide rod 10 passes through the guide device 71 on the support plate 7. The guide device 71 is a linear hole, and a diameter of the guide device 71 is slightly larger than a diameter of the guide rod, so that the guide rod 10 makes a linear motion in the guide device 71. The secondary drive rod 5 passes through the giving-way hole 72 on the support plate 7. A diameter of the giving-way hole 72 is at least greater than a diameter of the secondary drive rod 5 plus an eccentric distance, so that the secondary drive rod 5 is driven by the eccentric bearings 8 to make a circular motion. That is, driven by the eccentric bearings 8, the secondary drive rod 5 moves in a circumferential direction relative to an axis of the giving-way hole 72. The fixing hole 75 is used for fixing the primary drive rod 4.

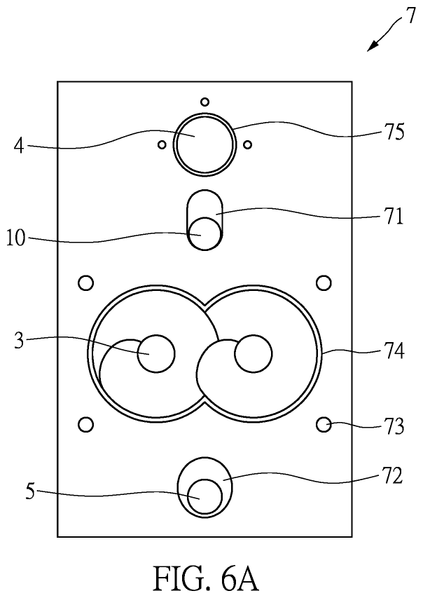

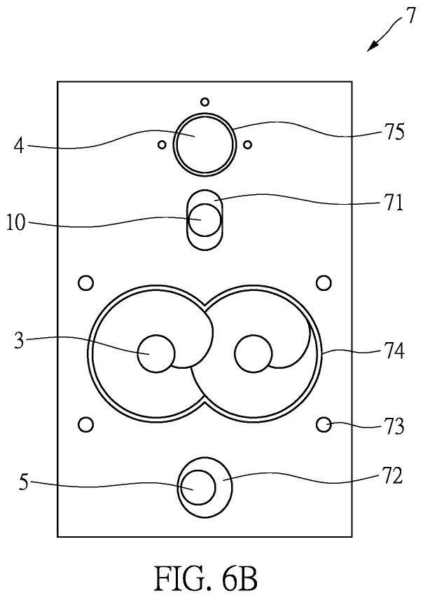

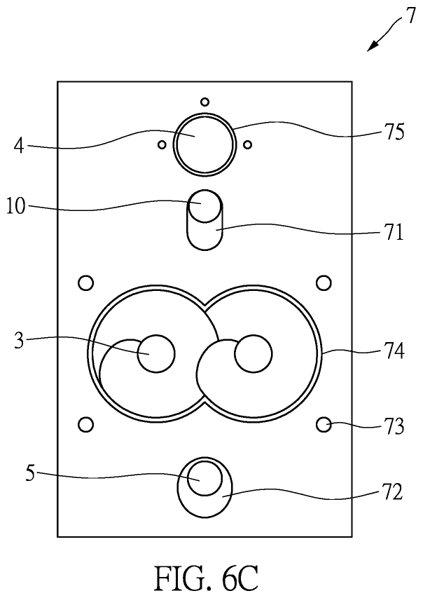

The screw shafts 3 drive the primary drive rod 4 to move via the transmission mechanism 6, the eccentric bearings 8 on the primary drive rod 4 drive the transmission movable rings 21 to move, and the transmission movable rings 21 drive all the movable rings 2 to move via the secondary drive rod 5. As shown in FIG. 6A to FIG. 6C, under the effect of the eccentric bearings 8 and the guide devices 71, the guide rod 10 drives the upper ends of all the movable rings 2 to make a linear motion. Under the effect of the eccentric bearings 8, the secondary drive rod 5 drives the lower ends of all the movable rings 2 to make the circular motion.

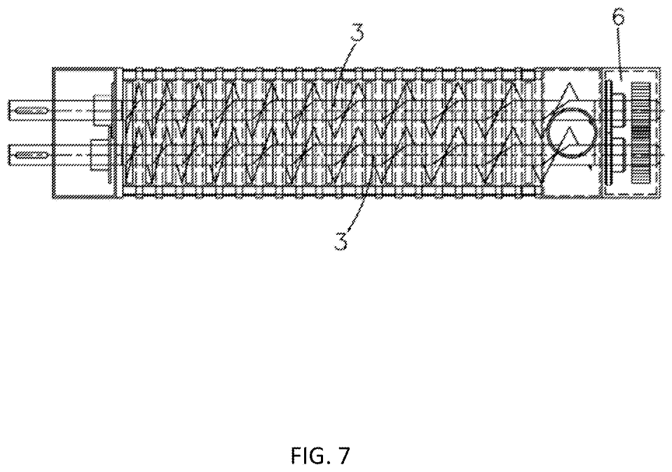

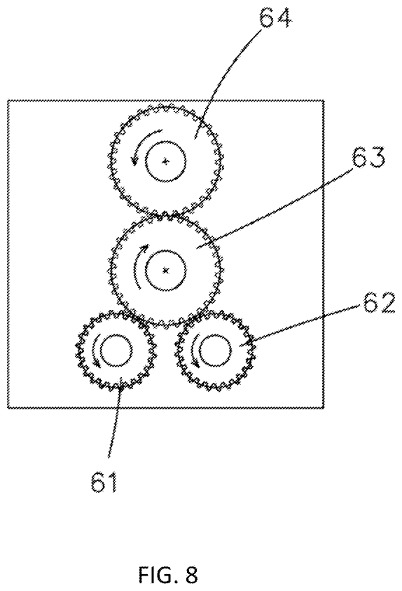

As shown in FIG. 7 and FIG. 8, the two screw shafts 3 are driven by a gear transmission mechanism 6 to operate in the same direction. The gear transmission mechanism 6 includes a driving screw shaft gear 61, a driven screw shaft gear 62, a transmission gear 63, and a primary drive rod gear 64. The transmission gear 63 engages with the driving screw shaft gear 61, the driven screw shaft gear 62, and the primary drive rod gear 64.

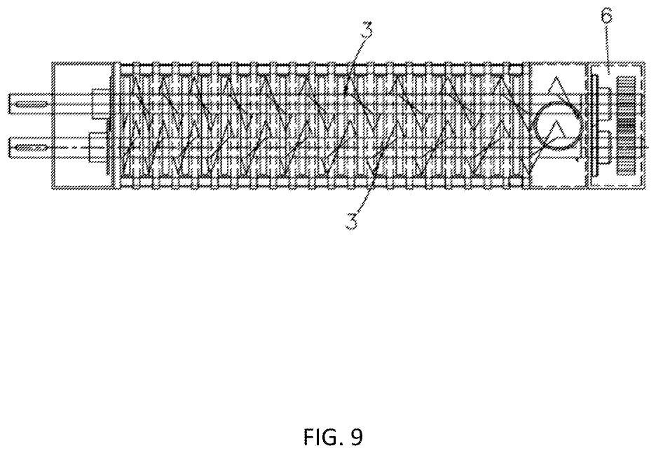

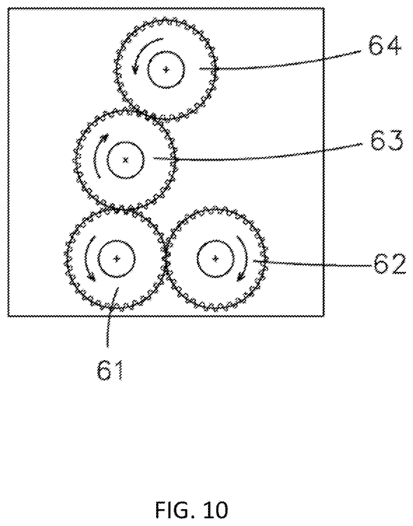

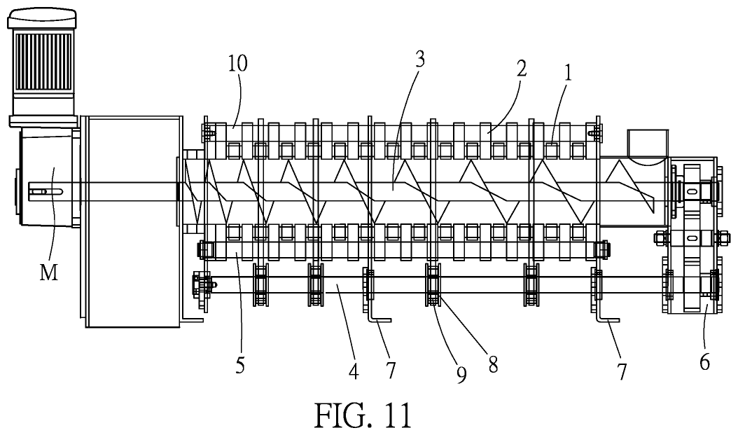

As shown in FIG. 9 and FIG. 10, the two screw shafts 3 are driven by a gear transmission mechanism 6 to operate in reverse directions. The gear transmission mechanism 6 includes the driving screw shaft gear 61, the driven screw shaft gear 62, the transmission gear 63, and the primary drive rod gear 64. The driving screw shaft gear 61 engages with the transmission gear 63 and the driven screw shaft gear 62; and the transmission gear 63 further engages with the primary drive rod gear 64.

### Second Embodiment

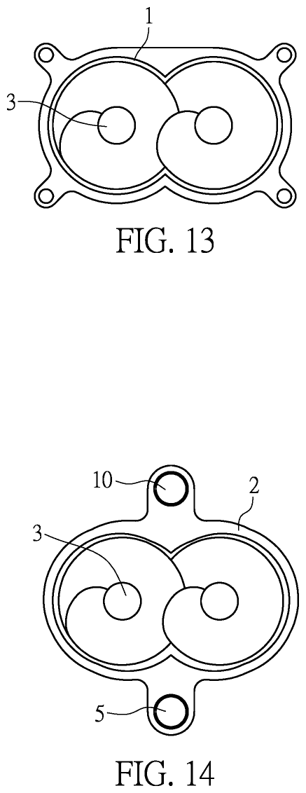

As shown in FIG. 11 to FIG. 15, which illustrates a multi-shaft laminated spiral solid-liquid separator according to a second embodiment of the present disclosure. The multi-shaft laminated spiral solid-liquid separator of the second embodiment is substantially the same as that of the first embodiment, and differences therebetween are described below.

In the present embodiment, the primary rod 4 and the secondary drive rod 5 are disposed on the same side of the cavity, that is, the primary rod 4 and the secondary drive rod 5 can be disposed on an upper side of the cavity or a lower side of the cavity. In one particular embodiment, as shown in FIG. 11, the primary rod 4 and the secondary drive rod 5 are disposed on the upper side of the cavity, and the primary rod 4 is arranged on a side facing a bottom of the secondary drive rod 5. In other words, the primary rod 4 is adjacent to the secondary drive rod 5 and away from the guide rod 10.

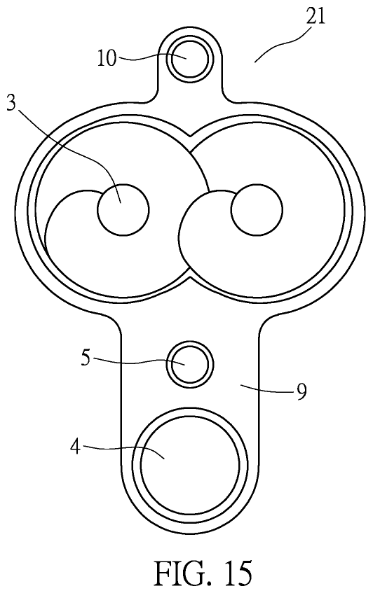

As shown in FIG. 15, the drive sheet 9 is arranged on a bottom side of the movable ring 2, and the movable ring 2 provided with the drive sheet 9 is referred to as the transmission movable ring 21. In addition, the second drive rod 5 passes through the one end of each of the movable rings 2, and the guide rod 10 passes through another end of each of the movable rings 2, thereby connecting all of the movable rings 2 together to form one piece.

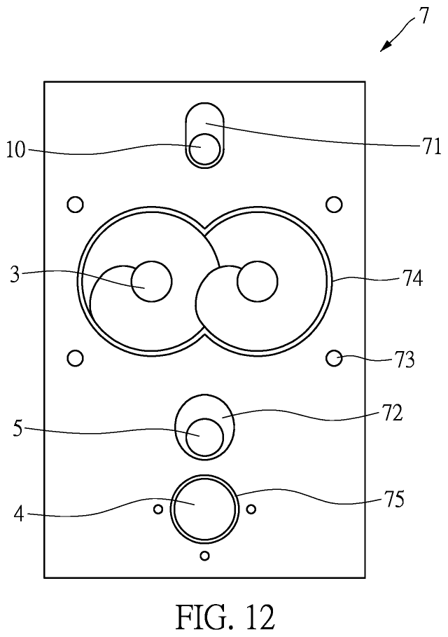

As shown in FIG. 11 and FIG. 12, the guide rod 10 passes through the guide device 71 on the support plate 7. The guide device 71 is a linear hole, and the diameter of the guide device 71 is slightly larger than the diameter of the guide rod, so that the guide rod 10 makes the linear motion in the guide device 71. The secondary drive rod 5 passes through the giving-way hole 72 on the support plate 7. The diameter of the giving-way hole 72 is at least greater than the diameter of the secondary drive rod 5 plus the eccentric distance, so that the secondary drive rod 5 is driven by the eccentric bearings 8 to make the circular motion. Therefore, driven by the eccentric bearings 8, the secondary drive rod 5 moves in a circumferential direction relative to an axis of the giving-way hole 72.

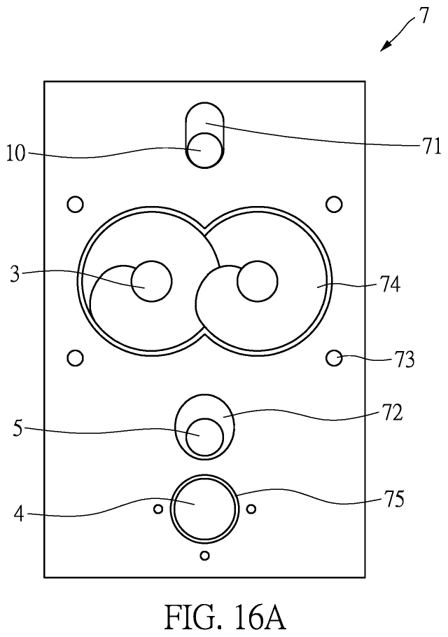

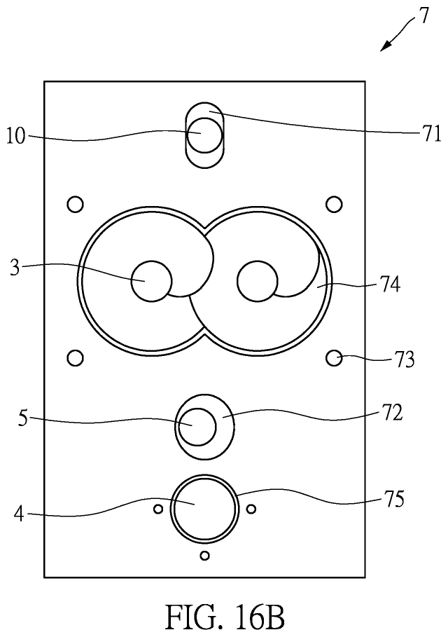

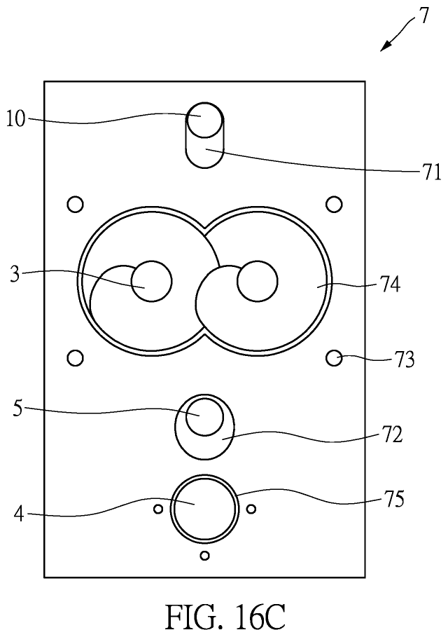

The screw shafts 3 drive the primary drive rod 4 to move via the transmission mechanism 6, the eccentric bearings 8 on the primary drive rod 4 drive the transmission movable rings 21 to move, and the transmission movable rings 21 drive all the movable rings 2 to move via the secondary drive rod 5. As shown in FIG. 16A to FIG. 16C, under the effect of the eccentric bearings 8 and the guide devices 71, the guide rod 10 drives the upper ends of all the movable rings 2 to make a linear motion. Under the effect of the eccentric bearings 8, the secondary drive rod 5 drives the lower ends of all the movable rings 2 to make the circular motion.

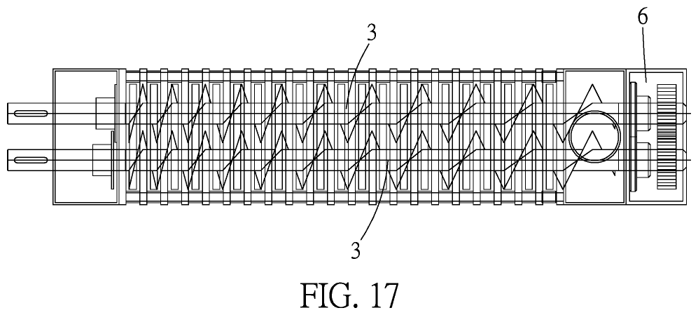

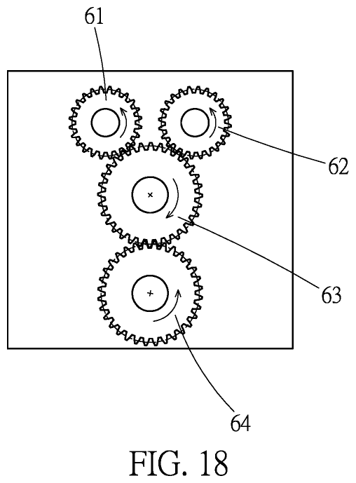

As shown in FIG. 17 and FIG. 18, the two screw shafts 3 are driven by a gear transmission mechanism 6 to operate in the same direction. The gear transmission mechanism 6 includes the driving screw shaft gear 61, the driven screw shaft gear 62, the transmission gear 63, and the primary drive rod gear 64. The transmission gear 63 engages with the driving screw shaft gear 61, the driven screw shaft gear 62, and the primary drive rod gear 64.

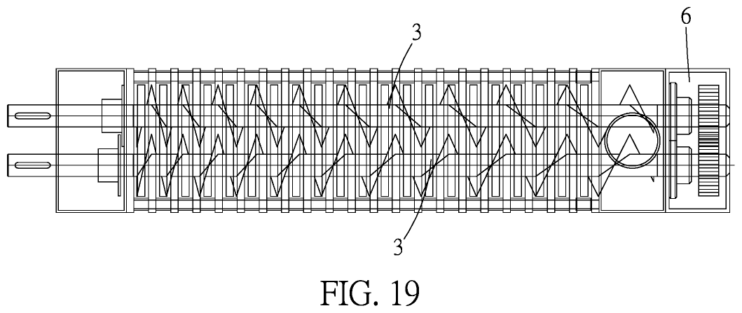

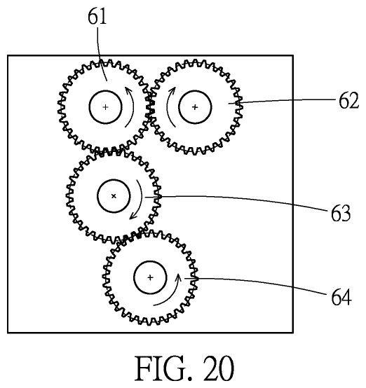

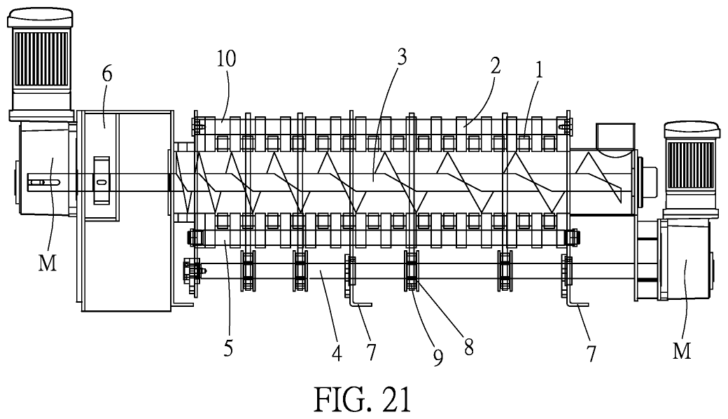

As shown in FIG. 19 and FIG. 20, the two screw shafts 3 are driven by a gear transmission mechanism 6 to operate in reverse directions. The gear transmission mechanism 6 includes the driving screw shaft gear 61, the driven screw shaft gear 62, the transmission gear 63, and the primary drive rod gear 64. The driving screw shaft gear 61 engages with the transmission gear 63 and the driven screw shaft gear 62; and the transmission gear 63 further engages with the primary drive rod gear 64.

### Third Embodiment

As shown in FIG. 21, which illustrates a multi-shaft laminated spiral solid-liquid separator according to a third embodiment of the present disclosure. The multi-shaft laminated spiral solid-liquid separator of the third embodiment is substantially the same as that of the second embodiment, and differences therebetween are described below.

In the present embodiment, the primary rod 4 is driven by an independent drive motor M. That is, two drive motors M are provided in the present embodiment, in which one of the two drive motors M is connected to the screw shafts 3, and another of the two drive motors M is connected to the primary rod 4. Therefore, the screw shafts 3 and the primary rod 4 can be driven independently by the two drive motors M. It should be noted that, the arrangement of the two drive motors M can be adjusted according to practical requirements, the present disclosure is not limited thereto.

The above merely describes preferred embodiments of the present application, but is not intended to limit the protection scope of the present invention. Any modifications, equivalent replacements or improvements made within the spirit and principle of the present application shall fall within the protection scope of the present invention.

What is claimed is:

1. A multi-shaft laminated spiral solid-liquid separator, comprising:
fixed rings, movable rings and screw shafts, wherein each of the screw shafts is provided with the fixed rings and the movable rings in a staggered arrangement in a radial direction to form a cavity;
two or more of the screw shafts arranged in the cavity side by side, and the fixed rings and the movable rings are in a form of an annular structure with two rings staggered and communicated or multiple rings staggered and communicated;
the separator further comprises a primary drive rod, a secondary drive rod, and a guide rod, wherein
the primary drive rod is connected to an independent drive motor, or is connected to the screw shafts via a transmission mechanism;
the primary drive rod is supported by two or more support devices, and one or more eccentric devices are provided on the primary drive rod;
the second drive rod passes through one end of each of the movable rings, the guide rod passes through another end of each of the movable rings, so as to connect all of the movable rings together to form one piece;
each of the eccentric devices is fixedly connected to a drive sheet, the drive sheet and a corresponding one of the movable rings are integrally formed, so that each of the eccentric devices is connected to the secondary drive rod via the drive sheet and the movable ring;
each of the support devices has a linear guide device and a giving-way hole, the guide rod passes through the linear guide device, the secondary drive rod passes through the giving-way hole, and a diameter of the giving-way hole is at least greater than a diameter of the secondary drive rod and an eccentric distance, so that the secondary drive rod drives the one end of the movable rings to make a circular motion while the guide rod drives the another end of the movable rings to move up and down by the linear guide device; and
the transmission mechanism or the drive motor drives the primary drive rod to move, the eccentric devices on the primary drive rod drive the secondary drive rod to move, and the secondary drive rod drives all the movable rings to move.

2. The multi-shaft laminated spiral solid-liquid separator of claim 1, wherein the primary drive rod and the guide rod are arranged on one side of the cavity, and the secondary drive rod is arranged on another side of the cavity.

3. The multi-shaft laminated spiral solid-liquid separator of claim 2, wherein the transmission mechanism is a gear transmission mechanism; there are two screw shafts; the screw shafts are driven by the gear transmission mechanism to operate in a same direction; the gear transmission mechanism comprises a driving screw shaft gear, a driven screw shaft gear, a transmission gear, and a primary drive rod gear; and the transmission gear engages with the driving screw shaft gear, the driven screw shaft gear, and the primary drive rod gear.

4. The multi-shaft laminated spiral solid-liquid separator of claim 3, wherein the transmission mechanism is a gear transmission mechanism; there are two screw shafts; the screw shafts are driven by a gear transmission mechanism to operate in reverse directions; the gear transmission mechanism comprises a driving screw shaft gear, a driven screw shaft gear, a transmission gear, and a primary drive rod gear; the driving screw shaft gear engages with the transmission gear and the driven screw shaft gear; and the transmission gear further engages with the primary drive rod gear.

5. The multi-shaft laminated spiral solid-liquid separator of claim 1, wherein the primary drive rod and the secondary drive rod are arranged on one side of the cavity; and the guide rod is arranged on another side of the cavity.

6. The multi-shaft laminated spiral solid-liquid separator of claim 5, wherein the transmission mechanism is a gear transmission mechanism; there are two screw shafts; the screw shafts are driven by the gear transmission mechanism to operate in the same direction; the gear transmission mechanism comprises a driving screw shaft gear, a driven screw shaft gear, a transmission gear, and a primary drive rod gear; and the transmission gear engages with the driving screw shaft gear, the driven screw shaft gear, and the primary drive rod gear.

7. The multi-shaft laminated spiral solid-liquid separator of claim 5, wherein the transmission mechanism is a gear transmission mechanism; there are two screw shafts; the screw shafts are driven by a gear transmission mechanism to operate in reverse directions; the gear transmission mechanism comprises a driving screw shaft gear, a driven screw shaft gear, a transmission gear, and a primary drive rod gear; the driving screw shaft gear engages with the transmission gear and the driven screw shaft gear; and the transmission gear further engages with the primary drive rod gear.
